(19) United States
(12) Patent Application Publication
(10) Pub. No.: US 2021/0129167 A1
(43) Pub. Date: May 6, 2021

(54) PROTECTIVE DEVICE FOR RIM OF TIRE FOR CLEANING OR TREATMENT

(71) Applicant: Shine Shield LLC, Roswell, GA (US)

(72) Inventors: Robert Leon Sapp, Jr., Dallas, GA (US); Lionel Dallas Webster, Roswell, GA (US)

(21) Appl. No.: 17/085,999

(22) Filed: Oct. 30, 2020

Related U.S. Application Data
(60) Provisional application No. 62/929,411, filed on Nov. 1, 2019.

(51) Int. Cl. B05B 12/30

(52) U.S. Cl. CPC B05B 12/30

(57) ABSTRACT

Disclosed herein is a rim shield device. The rim shield device may comprise a singular planar body comprising a plurality of orifices. The planar body may be generally a semicircle.

### TECHNOLOGY FIELD

The disclosure relates generally to a device for protecting a tire rim while applying a tire cleaning or protectant solution to the rubber portion of a tire.

### BACKGROUND

Cleaning of vehicle tires is an important component of tire care. A cleaning solution or protectant are applied whether via spray-, brush-, or rub-on application. Much care is often taken in cleaning and treating a rubber portion of a vehicle tire to prevent tire treatment solutions or protectants from contacting the wheel rim adjacent the tire. While these solutions may protect or clean the tire, they are often specifically suited for the material comprising the tire, such as rubber. These solutions are not designed for, and may often be abrasive to materials comprising the wheel rim. Accordingly, there is a need for a protective removable shield that prevent the wheels or wheel rim from being sprayed or contacted undesirably when rubber tires mounted on the wheels are being sprayed with a protective shiny coating, washed, or otherwise having liquid applied thereto. Such a shield or cover is desirably easy to place and to remove, as well as available in various diameters to fit various size wheels and wheel covers.

U.S. Pat. No. 4,874,206 discloses a wheel rim mask or shield that includes a core that has peripheral hooked rims attachable thereto.

U.S. Pat. No. 6,863,353 discloses a domed covering element sized to cover and protect an entire wheel rim.

U.S. Pat. No. 8,668,277 discloses an expandable shield for the rim and hub of a wheel. The expandable shield comprises multiple panels, a blade assembly, threaded bolts, and several covering blades.

U.S. Pat. No. 9,713,819 discloses a shield for a rim of vehicle wheel comprising a rigid, circular panel and brace.

While individual devices have been introduced to ease masking of tire rims, there remains a need in the art for a durable, accessible, and versatile device for shielding a wheel rim during tire treatment or cleansing. These and other shortcoming are addressed in the present disclosure.

### SUMMARY

Aspects of the present disclosure relate to a rim shield device comprising a singular planar body, wherein the planar body comprises at least a portion of a disc and wherein the at least a portion of a disc comprises a series of orifices. The rim shield device may be configured to be disposed adjacent a vehicle tire to facilitate cleaning of the vehicle tire without soiling a tire rim of the tire.

Those skilled in the art of automotive care materials and methods will appreciate these and other features and their advantages from a careful review of the Detailed Description accompanied by the following drawings.

### BRIEF DESCRIPTION OF THE DRAWINGS

Referring now to the drawings,

FIG. 1 is a straight view of the device;

FIG. 2 is a rendering of the device in use adjacent a vehicle tire rim;

FIG. 3 is a flow diagram of an example method according to aspects of the present disclosure.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims.

### DETAILED DESCRIPTION

Automobile wheels and tires often require detailing or cleaning. As automobile tires are generally mounted to wheels, motorists often spray the rubber tire vehicles with a protective shiny finish or coating or otherwise attempt to clean or protect the rubber tires. Great care is often taken in cleaning and treating a rubber portion of a vehicle tire to prevent tire treatment solutions or protectants from contacting the wheel rim. Though these are designed to protect or cleanse the tire, they may be damaging or simply undesirable for contact with the wheel rim. Such solutions on these surfaces may also facilitate buildup on the tire rim overtime. The tire cleaning protective solutions are generally meant for tire surfaces, such as rubber and the like, but not intended for the metal surfaces of the tire rim or any interior wheel parts. For example, as protectant solutions or “tire shine” is applied to the wheel, brake dust on the rim can adhere easily. If tire shine is on the rim, the regularly released brake dust may build upon itself and build upon intricate components at the wheel base such as the calipers, brake pads, and other internal components. This problem may be worsened if a spray device is used to deliver the solution, as is common in application of tire shine and the like to vehicle wheels.

A number of devices have been developed to ease masking of wheel rims, however these tools may lack durability or include inconvenient components to adhere to the wheel rim or tire itself. These devices may prevent a user from freely maneuvering along or about a circumference of a wheel rim. Other devices may comprise multiple pieces or protruding portions that may be susceptible to damage and that prevent direct application to a rim surface. Such protective devices may also be more difficult to remove from the rim surface. These disadvantages can frustrate, and ultimately prolong, the overall detailing process.

The present disclosure provides a novel, easy to use rim shield device for a wheel rim. In general, placing a rim shield device at a wheel rim of an automobile allows a user to prevent undesirable solvents or solutions from contacting the surface of the wheel rim. The protective device may be placed flush at a tire rim because the surface of the protective device is unobstructed or substantially unobstructed. Conventional instruments configured for protection of a wheel's rim during cleaning or treatment often include multiple components or fastening members to removably adhere to a wheel rim. These components however may make conventional instruments bulky or hard to use as well as subject to gradual wear and damage of the protruding members. According to aspects of the present disclosure, a user can freely orient a semicircular, planar body to protect at least a portion of a wheel rim. The disclosed rim shield device may provide greater flexibility and efficiency protecting a wheel rim during the application of a cleaning or treatment solution to a wheel's tire.

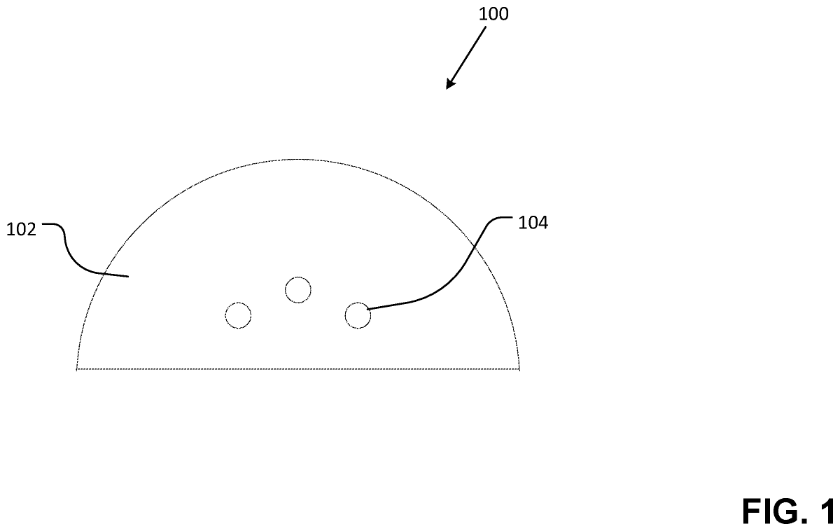

A tire rim shield device of the present disclosure may provide an efficient way to screen or cover the rim of a vehicle tire. As such, the tire rim shield may be a useful automotive care product. The tire rim shield device may be described as a protective shield in certain aspects. The protective shield may comprise a singular planar body (e.g., 102, FIG. 1) that comprises a plurality of orifices (e.g., 104, FIG. 1). The foregoing components of the protective shield device and their accompanying features are described in further detail below.

In ordinary use of the disclosed protective shield or protective shield device, the planar body of the protective shield device may be disposed adjacent a tire rim. The orifices of the planar body allow a user to situate the planar body at a surface of a tire rim. A user may then apply a solvent or solution of choice to the tire without concern that solvent or solution will contact the tire rim. FIG. 1 shows the protective shield device 100 comprising a planar body 102 having a plurality of orifices 104.

The protective shield device 100 may comprise a planar body 102, wherein the planar body is singular. In various aspects of the presented disclosure, the protective shield 100 is a rim shield device 100 for a vehicle wheel. A singular planar body as used herein describes the nature of the figure of the rim shield device. “Singular” as used herein to refer to the planar body of the protective shield device may indicate that the planar body is comprised of a single or unitary body or figure or frame. For example, the device comprises a single piece or single figure rather than multiple components, segments, or affixing pieces. This characteristic of the protective shield make thermoplastic extrusion of the rim shield device a possible route of manufacture.

The rim shield device 100 may comprise a planar body having a smooth surface free of obstructions or protrusions so as to allow the planar body to be disposed adjacent a vehicle tire. Planar body may indicate that the rim shield device 100 is flat or substantially flat so that the rim shield device is configured to be disposed adjacent a wheel rim of vehicle without substantial gap or space there between.

Planar body may also describe a surface of the rim shield device that is disposed adjacent the vehicle wheel. Planar body may indicate that the surface of the device is free of or substantially free of protrusions or projections that might impede contact with a substantially flat surface. Thus, the rim shield device may be configured to fully or substantially fully contact a flat surface. In various aspects, the rim shield device may abut a tire rim.

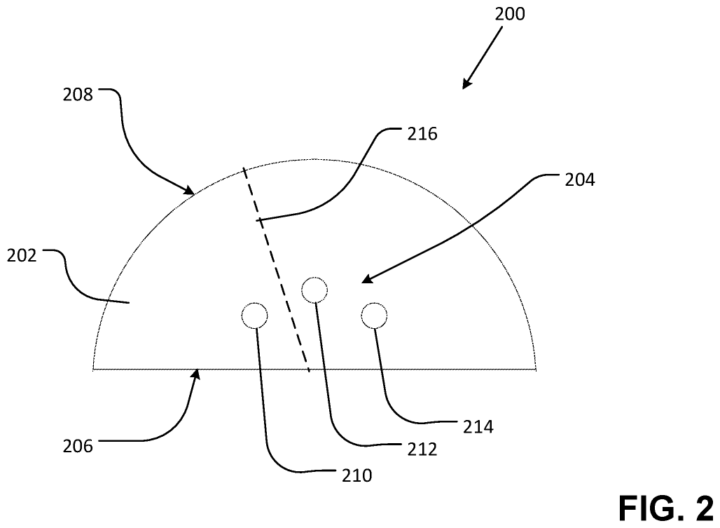

In further aspects, the planar body is generally a semicircle or a semicircular figure. A semicircular figure or body may describe a figure or shape consisting of half, or about half, of a circle, and a diameter of that circle. In further examples, the planar body may be described as a portion of a disc comprising a semicircular halve. By way of illustration, the semicircular figure of the planar body may be a half circle generated by dividing a full circle along a diameter line. For example, referring to FIG. 2, the semicircular figure of the planar body 202 may include a straight edge 206 which may correspond to a diameter of a full circle and a curved portion 208 which may correspond to at least a portion of the full circle's circumference.

Wheel rims and their respective tires are available in various sizes. The rim shield device may be sized to cover and protect a wheel rim during cleaning or treatment. Thus, the disclosed device may be manufactured accordingly so a straight edge 206 of the planar body corresponds to a diameter of the wheel rim, such that the planar body may readily cover at least a portion of the area of the wheel rim. As provided above, the straight edge 206 may correspond to a diameter of a wheel rim, and a span 216 of the planar body may correspond to the radius of the of wheel rim. A user of the disclosed device may select a device of the appropriate size to sufficiently cover the area of the wheel at the portion of the tire to be cleansed or treated. As an example, a rim shield device having a 15 inch, in. (38.1 cm) straight edge may be useful for protecting at least a portion of a wheel rim having a 15 in. diameter.

Referring again to FIG. 2, the rim shield device 200 may comprise a planar body 202 having one or more orifices 204. One or more orifices 204 may be situated within the planar body 202 to accommodate a user's hand appendages while the rim shield device is in use. In an aspect, the planar body 202 may have at least one orifice 204 to allow the planar body to be gripped with one hand. In further examples the planar body may have two, three, or four orifices. In a specific example, the planar body has three orifices. As an illustration, and not to be limiting, a user may place a thumb in a first orifice 210, a forefinger of the same hand in a second orifice 212, and middle finger 214 of the same hand in a third orifice. The one or more orifices of the planar body may be spaced so as to accommodate insertion of a user's fingers. For example, the one or more orifices may be spaced in relation to one another so as to comfortably accommodate a user's fingers.

The one of more orifices of the planar body may be spaced at certain positions in the planar body. In certain aspects, the one or more orifices 204 are centered along the straight edge 206 of the planar body. This position may allow a user to appropriately balance the protective device against a surface of the tire rim. In further aspects, the one or more orifices are spaced a distance from the straight edge 206 of the semicircular, planar body 202 of the rim shield device 200. According to various aspects, each orifice of the one or more orifices 204 may be equidistant from the straight edge 206. In a specific example however, the one or more orifices may be spaced at different distances from the straight edge of the semicircular body. Varying distances may allow a user to comfortably insert an appendage at each orifice and easily operate the rim shield device during cleaning or treatment of a vehicle tire.

Orifices may be of any shape or size suitable to receive a user's appendage or fingers. In some aspects, the one or more orifices may have a circular, oval, oblong, rectangular, triangular, or other shape. To comfortably allow a user's hand appendages or fingers, an orifice of the one or more orifices may have a size such that at least a dimension of the orifice has a value of at least 0.6 in. (1.5 centimeters, cm), or at least 0.79 in. (2.0 cm), or at least 0.87 in. (2.2 cm), or at least 0.98 in. (2.5 cm). In various aspects, an orifice of the one or more may have at least one dimension of from about 0.5 in. (1.27 cm) to about 2 in. (5.08 cm). The one or more orifices may be of the same size and same shape, or may vary according to size and shape.

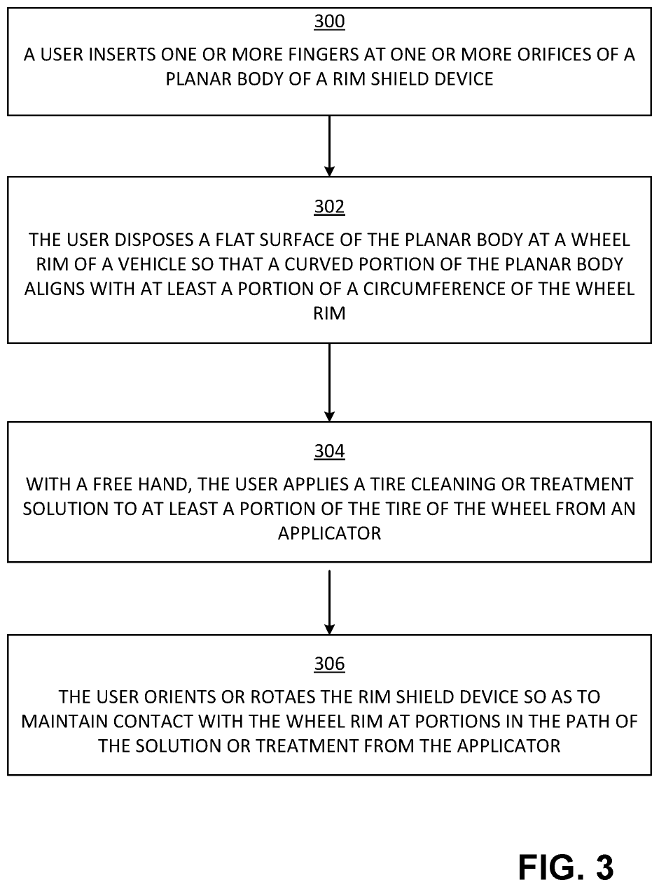

The rim shield device is configured to be disposed adjacent a vehicle tire to facilitate cleaning of the tire without soiling a tire rim of the wheel. FIG. 3 provides a diagram of an example method for use of the disclosed rim shield device. At 300, a user may insert one or more fingers at the orifices of the planar body. At 302, the user may dispose a flat surface of the planar body of the rim shield device at a wheel rim of a vehicle so that a curved portion of the planar body aligns with at least a portion of a circumference of the wheel rim. With a free hand, the user may apply a desired tire cleaning or treatment solution at step 304. As an example, the tire cleaning or treatment solution may be administered via a spray applicator. The user positions the rim shield device to prevent the solution from contacting the wheel rim. At step 306, the user may freely orient or rotate the rim shield device so as to maintain contact with the wheel rim at portions in the path of the solution or treatment from the applicator. Because the user can freely orient the planar body of the rim shield device, the user is afforded greater flexibility in quickly and efficiently applying the treatment solution while covering the portions of the wheel rim in the path of solution from the sprayer or applicator.

According to various aspects of the present disclosure, as the rim shield device is held in place with one hand, it is desirable that the device comprises a lightweight materials, such as a thermoplastic material. Useful materials also include those that are inert or non-reactive with solvents or solutions used with tire care. These materials may provide a device which is lightweight, inexpensive and easy to use.

Suitable thermoplastic materials may include (ethylene vinyl acetate, ethylene acrylate, ethylene methacrylate, ethylene methyl acrylate, ethylene methyl methacrylate, ethylene vinyl acetate carbon monoxide and ethylene/n-Ethylene-based polymers (such as butyl acrylate carbon monoxide), polybutene-1, high density polyethylene and low density polyethylene, polyethylene blends and chemically modified polyethylene, copolymers of ethylene and C₁-C₆ mono- or diunsaturated monomers, polyamides, polybutadiene rubber Polyesters (such as polyethylene terephthalate, polyethylene naphthalate, polybutylene terephthalate); thermoplastic polycarbonates (atactic) (Including propylene) atactic polyalphaolefin, livinylmethyl ether, etc.; thermoplastic polyacrylamide, polyacrylonitrile, copolymers of acrylonitrile, and other monomers such as butadiene styrene; polymethylpentene, polyphenylene sulfide, aromatic polyurethane; Styrene acrylonitrile, acrylonitrile butadiene styrene, styrene-butadiene rubber, acrylonitrile butadiene styrene elastomer, polyphenylene sulfide, A-B, A-B-A, A-(B-A) B, (A-B)ₙ-Y block Polymer (A block comprises a polyvinyl aromatic block such as polystyrene and B block is a polyisoprene such as polybutadiene optionally hydrogenated. A rubber intermediate block to be obtained, Y comprising a polyvalent compound and n being an integer of at least 3), as well as mixtures of these substances. In certain embodiments, the thermoplastic material is polyethylene terephthalate (PET). PET is a readily available thermoplastic sold by many different manufacturers. In line with these contexts, the thermoplastic polymer used to make the rim shield device may be transparent, opaque, or partially opaque. In a particular example, the material comprises a transparent polymer, such as an acrylic.

Although desirably lightweight, the disclosed rim shield device further provides a durable means of wheel rim protection. Generally, the semicircular figure of the planar body comprising the rim shield device is rigid such that the full planar body may be disposed adjacent the wheel rim in a substantially flush manner. And, comprised of suitable thermoplastics, the rim shield device is thus durable and shatter-resistant.

The present disclosure relates to at least the following aspects.

Aspect 1. A protective shield comprising: A singular planar body comprising a plurality of orifices, wherein the planar body is generally a semicircle.

Aspect 2. The protective shield of aspect 1, wherein the planar body comprises a thermoplastic or thermoset resin.

Aspect 3. The protective shield of any of aspects 1-2, wherein the planar body comprises an acrylic polymer.

Aspect 4 The protective shield of any of aspects 1-3, wherein the planar body comprises a transparent polymer.

Aspect 5. The protective shield of any of aspects 1-4, wherein the plurality of orifices are configured to accommodate insertion of a user's fingers.

Aspect 6. The protective shield of any of aspects 1-4, wherein the plurality of orifices are spaced so as to accommodate insertion of a user's fingers.

Aspect 7. The protective shield of any of aspects 1-6, wherein the plurality of orifices comprises at least two orifices.

Aspect 8. The protective shield of any of aspects 1-7, wherein the plurality of orifices are configured so as to allow the planar body to be gripped with one hand.

Aspect 9. The protective shield of any of aspects 1-8, wherein the protective shield is an automotive care product.

Aspect 10. The protective shield of any of aspects 1-9, wherein the shield is configured to be disposed adjacent a vehicle tire to facilitate cleaning of the tire.

Aspect 11. The protective shield of any of aspects 1-10, wherein the planar body comprises a smooth surface free of obstructions or protrusions so as to allow the planar body to be disposed adjacent a vehicle tire.

Aspect 12. A rim shield device comprising: A singular planar body, wherein the planar body comprises at least a portion of a disc and wherein the at least a portion of a disc comprises a series of orifices, and wherein the shield is configured to be disposed adjacent a vehicle tire to facilitate cleaning of the vehicle tire without soiling a tire rim of the tire.

Aspect 13. The rim shield device of aspect 12, wherein the planar body comprises a thermoplastic or thermoset resin.

Aspect 14. The rim shield device of any of aspects 12-13, wherein the at least a portion of a disc comprises a semicircular halve.

Aspect 15. The rim shield device of any of aspects 12-14, wherein the planar body is rigid.

Aspect 16. The rim shield device of any of aspects 12-15, wherein the planar body comprises an acrylic polymer.

Aspect 17. The rim shield device of any of aspects 12-16, wherein the plurality of orifices comprises at least two orifices.

Aspect 18. The rim shield device of any of aspects 12-17, wherein the plurality of orifices are configured so as to allow the planar body to be gripped with one hand.

Aspect 19. The rim shield device of any of aspects 12-18, wherein the rim shield device is an automotive care product.

Aspect 20. The rim shield device of any of aspects 12-19, wherein the rim shield device is configured to be disposed adjacent a vehicle tire to facilitate cleaning or treatment of tire.

Aspect 21. The rim shield device of any of aspects 12-20, wherein the planar body comprises a smooth surface free of obstructions or protrusions so as to allow the planar body to be disposed adjacent a vehicle tire.

It is to be understood that unless otherwise expressly stated, it is in no way intended that any method or operational flow set forth herein be construed as requiring that its steps be performed in a specific order. This holds for any possible non-express basis for interpretation, including: matters of logic with respect to arrangement of steps or operational flow; plain meaning derived from grammatical organization or punctuation; and the number or type of embodiments described in the specification.

Various aspects of the present disclosure have been described in fulfillment of the various needs that the disclosure meets. It should be recognized that these aspects are merely illustrative of the principles of various embodiments of the present disclosure. Aspects (e.g., Aspect 1-21) may be removed, interchanged, or reordered. Numerous other modifications and adaptations thereof will be apparent without departing from the spirit and scope of the present disclosure. Thus, it is intended that the present invention cover all suitable modifications and variations as come within the scope of the appended claims and their equivalents.

Although the present disclosure has been described in considerable detail with reference to certain preferred versions thereof, other versions are possible. Therefore, the spirit and scope of the appended claims should not be limited to the description of the preferred versions contained herein. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Definitions

It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural equivalents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

As used herein, the term “diameter” may refer to a measure of the distance from one point on a circle (or sphere) through the center to another point on the circle.

As used herein the term, “circumference” may refer to a measure the enclosing boundary of a curved geometric figure, especially a circle.

As used herein, the term “acrylic” may refer to a synthetic resin derived from acrylic and methacrylic acid.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±5% variation unless otherwise indicated or inferred. The term is intended to convey that similar values promote equivalent results or effects recited in the claims. For example, it is understood that amounts, sizes, formulations, parameters, and other quantities and characteristics are not and need not be exact, but may be approximate or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise. In addition, the use of the word “or” is generally used inclusively unless otherwise provided herein.

Disclosed are the components to be used to form the nested liner assembly disclosed herein. These and other materials are disclosed herein, and it is understood that when combinations, subsets, interactions, groups, etc. of these materials are disclosed that while specific reference of each various individual and collective combinations and permutation of these components cannot be explicitly disclosed, each is specifically contemplated and described herein. This concept applies to all aspects of this application including, but not limited to, steps in methods of using the assembly of the present disclosure. Thus, if there are a variety of additional steps that may be performed it is understood that each of these additional steps can be performed with any specific aspect or combination of aspects of the methods of the disclosure.

It will be apparent to those skilled in the art that various modifications and variations may be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A protective shield comprising:
A singular planar body comprising a plurality of orifices, wherein the planar body is generally a semicircle.

2. The protective shield of claim 1, wherein the planar body comprises a thermoplastic or thermoset resin.

3. The protective shield of claim 1, wherein the planar body comprises an acrylic polymer.

4. The protective shield of claim 1, wherein the planar body comprises a transparent polymer.

5. The protective shield of claim 1, wherein the plurality of orifices are configured to accommodate insertion of a user's fingers.

6. The protective shield of claim 1, wherein the plurality of orifices are spaced so as to accommodate insertion of a user's fingers.

7. The protective shield of claim 1, wherein the plurality of orifices comprises at least two orifices.

8. The protective shield of claim 1, wherein the plurality of orifices are configured so as to allow the planar body to be gripped with one hand.

9. The protective shield of claim 1, wherein the protective shield is an automotive care product.

10. The protective shield of claim 1, wherein the shield is configured to be disposed adjacent a vehicle tire to facilitate cleaning of the tire.

11. The protective shield of claim 1, wherein the planar body comprises a smooth surface free of obstructions or protrusions so as to allow the planar body to be disposed adjacent a vehicle tire.

12. A rim shield device comprising:
A singular planar body, wherein the planar body comprises at least a portion of a disc and wherein the at least a portion of a disc comprises a series of orifices, and
wherein the shield is configured to be disposed adjacent a vehicle tire to facilitate cleaning of the vehicle tire without soiling a tire rim of the tire.

13. The rim shield device of claim 12, wherein the planar body comprises a thermoplastic or thermoset resin.

14. The rim shield device of claim 12, wherein the at least a portion of a disc comprises a semicircular halve.

15. The rim shield device of claim 12, wherein the planar body is rigid.

16. The rim shield device of claim 1, wherein the planar body comprises an acrylic polymer.

17. The rim shield device of claim 1, wherein the plurality of orifices comprises at least two orifices.

18. The rim shield device of claim 1, wherein the plurality of orifices are configured so as to allow the planar body to be gripped with one hand.

19. The rim shield device of claim 1, wherein the rim shield device is an automotive care product.

20. The rim shield device of claim 1, wherein the planar body comprises a smooth surface free of obstructions or protrusions so as to allow the planar body to be disposed adjacent a vehicle tire.
